(19) United States
(12) Patent Application Publication
(10) Pub. No.: US 2009/0033125 A1
(43) Pub. Date: Feb. 5, 2009

(54) Front Guard of Working Vehicle

(75) Inventors: Hiroaki Ayabe, Fukuoka (JP); Nagahiro Ogata, Fukuoka (JP); Kouichi Takata, Fukuoka (JP)

Correspondence Address: STERNE, KESSLER, GOLDSTEIN & FOX P.L.L.C., 1100 NEW YORK AVENUE, N.W., WASHINGTON, DC, 20005, US

(73) Assignee: Yanmar Co., Ltd, Osaka (JP)

(21) Appl. No.: 12/160,069

(22) PCT Filed: Aug. 25, 2006
(86) PCT No.: PCT/JP2006/316714

§ 371 Date: Sep. 26, 2008

(30) Foreign Application Priority Data
Jan. 16, 2006 (JP) 2006-007215

(51) Int. Cl. B60J 11/00

(52) U.S. Cl. 296/187.09

(57) ABSTRACT

A front guard 10 of a working vehicle 1 is mounted onto a bracket 11 fixed on a front portion of a vehicle body frame 9 so as to be disposed in front of a bonnet 30. A top of front guard 10 slightly projects upward from an eyeshot of an operator sitting on an operation seat 4, the eyeshot being directed to a front upper portion of bonnet 30, so that the top of front guard 30 can be seen by the operator and does not obstruct the operator's ken for working.

### TECHNICAL FIELD

The invention relates to a front guard disposed in front of a vehicle body of a working vehicle.

### BACKGROUND ART

As well known, in a conventional working vehicle, a structure such as a front guard is disposed in front of a vehicle body so as to protect implements, such as a radiator and an oil cooler, which are disposed in front of the vehicle body, from unexpected shock or so on during working.

However, the mounted front guard obstructs an operator's eyeshot, so that, for example, the operator cannot clearly view a working device, such as a bucket, attached to the working vehicle, thereby reducing workability.

### BRIEF SUMMARY OF THE INVENTION

### Object

An object to be achieved is to provide a front guard to be mounted so as not to obstruct an operator's eyeshot and not to reduce the workability.

### Way for Solving the Problem

A front guard of a working vehicle according to the invention is mounted onto a bracket fixed on a front portion of a vehicle body frame so as to be disposed in front of a bonnet. A top of the mounted front guard slightly projects upward from an eyeshot of an operator sitting on an operation seat, the eyeshot being directed to a front upper portion of the bonnet, so that the top of the front guard can be seen by the operator and does not obstruct the operator's ken for working.

### EFFECT OF THE INVENTION

According to the invention, when the front guard is mounted on the working vehicle, the operator sitting on the operation seat can constantly view a working device provided on the working vehicle. Therefore, the front guard of the working vehicle protects the vehicle body without obstructing the operator's ken for working and without reducing the workability.

### BRIEF DESCRIPTION OF THE DRAWINGS

FIG. 1 is a side view of an entire working vehicle according to an embodiment of the present invention.

FIG. 2 is a perspective view of a front portion of the vehicle (when a front guard is not mounted).

FIG. 3 is a perspective view partly in section of the front portion of the working vehicle.

FIG. 4 is a perspective view of a front guard.

FIG. 5 is a front view of the front guard.

FIG. 6 is a schematic side view of arrangement of the front guard and an operator's ken for working.

### DESCRIPTION OF NOTATIONS

1 Working Vehicle
8 Front Wheel
9 Vehicle Body Frame
10 Front Guard
11 Bracket

### BEST MODE FOR CARRYING OUT THE INVENTION

A mode for carrying out the invention will be described.

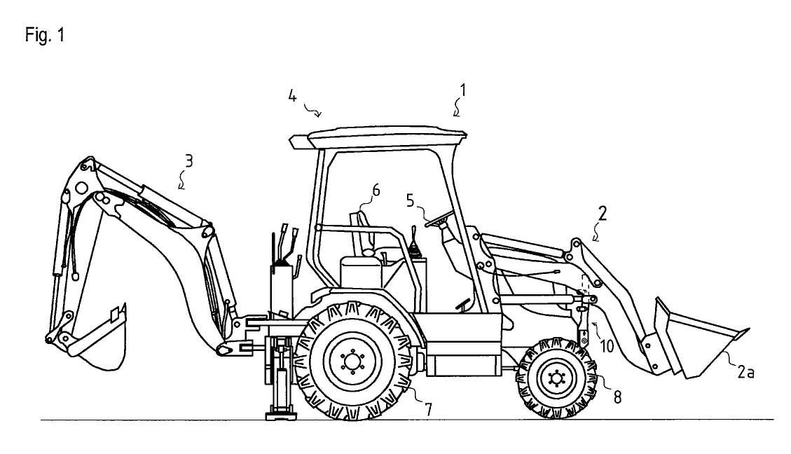

First of all, a working vehicle according to an embodiment as an application of the invention will be described with reference to FIG. 1.

As shown in FIG. 1, a working vehicle 1 is a tractor-loader-backhoe equipped with a loader 2 and an excavator 3. An operation section 4 is provided at a center portion of working vehicle 1. Loader 2 is disposed in front of operation section 4, and excavator 3 is disposed behind operation section 4. Working vehicle 1 is provided with front wheels 8 and rear wheels 7 so as to enable to travel while having loader 2 and excavator 3.

A steering wheel 5 and an operation seat 6 are disposed in operation section 4. Operation devices for traveling and for loader 2 are disposed beside operation seat 6. Therefore, operation section 4 is provided for steering operation of working vehicle 1 and for operation of loader 2.

Loader 2 serving as a device for loading particles has lift arms, which are connected to side portions of working vehicle 1 and are extended forward, and has a bucket 2a attached on tips of the lift arms.

Excavator 3 is detachably attached onto a rear portion of working vehicle 1. Operation devices for excavator 3 are provided behind operation seat 6.

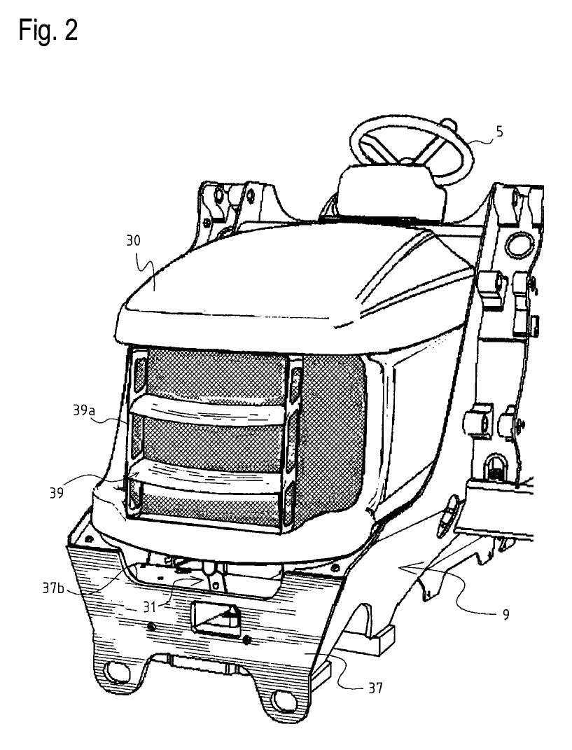

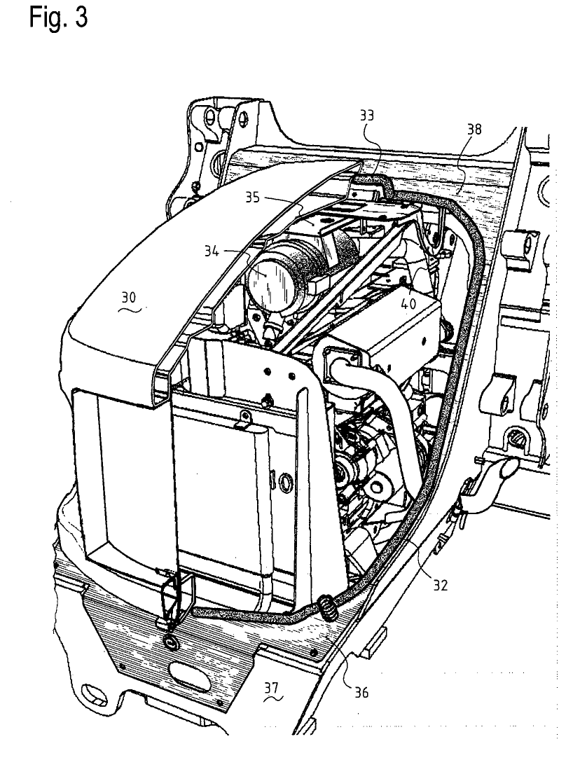

A structure of a front portion of working vehicle 1 will now be described with reference to FIGS. 2 and 3.

In this regard, FIGS. 2 and 3 show a state of the working vehicle before it is provided with a front guard serving as a subject of the invention.

As shown in FIG. 2, working vehicle 1 has vehicle body frames 9 extended fore-and-aft and disposed on left and right sides, and is provided with a bonnet 30 on vehicle body frames 9 at a front portion thereof. Bonnet 30 is made of resin and is formed in a hollow structure. Bonnet 30 is disposed in front of operation section 4 of working vehicle 1 so as to enclose an engine disposed on frames 9. In bonnet 30 are disposed the engine with engine attachments such as a radiator, a muffler and an air cleaner 34, a hydraulic pump, an oil cooler and so on.

Bonnet 30 openably closes on frames 9, so that bonnet 30 is opened by upwardly rotating a front portion thereof. In this regard, each of arms 40 is fixed at one end thereof to an inner side surface of a rear portion of bonnet 30, and is rotatably supported at a rear end thereof by frame 9 through a hinge.

Bonnet 30 is integrally formed to have parts covering the top, right, left and front surfaces of the engine. Bonnet 30 is retained at a laterally middle front and lower portion thereof by a locking mechanism 31 so as to hold its closing state. Locking mechanism 31 is interposed between frames 9 and bonnet 30, and includes a locking stay mounted on bonnet 30 and a hook provided on frames 9. When bonnet 30 closes and the stay and hook are engaged with each other, bonnet 30 is locked to frames 9.

Frames 9 are provided at front ends thereof with a front plate 37 so as to be fixedly connected to each other through front plate 37. In the state without a cover 36 as shown in FIG. 2, front plate 37 is provided at a laterally middle upper portion thereof with a notch 37b through which locking mechanism 31 is visible. Due to the downward notch at the upper middle portion of front plate 37, when frames 9 and bonnet 30 are engaged with each other, locking mechanism 31 is visible so as to facilitate positional adjustment of bonnet 30 and locking mechanism 31.

Right and left frames 9 are provided with a rib 38 inside of their front portions, such as to be adapted to fit along a bottom peripheral edge of bonnet 30. In other words, rib 38 projects from frames 9 to the periphery of the engine room. A seal 32 is fitted onto rib 38 so as to seal a gap between frames 9 and bonnet 30. Seal 32 contacts the bottom peripheral edge of bonnet 30 so as to prevent the edge of bonnet 30 from introducing air or water thereinto. Bonnet 30 is provided at a front surface thereof with an opening (a bonnet grill 39) serving as a cooling air intake. The cooling air introduced into bonnet 30 through this opening passes the radiator, cools the engine, and is exhausted downward. Seal 32 contacting the bottom peripheral edge of bonnet 30 prevents the cooling air from leaking from the gap between the edge of bonnet 30 and frames 9 (rib 38).

As shown in FIG. 3, cover 36 is provided to cover notch 37b of front plate 37, the front upper surface of frame 9 and so on. Cover 36 is a plate bent in a reversed L-like shape when viewed in side. Cover 36 is formed to have a substantially trapezoidal front surface such as to cover notch 37b. Cover 36 is shaped at an upper surface thereof so as to fit a front bottom edge of bonnet 30 for closing gaps on front upper surfaces of frames 9. Cover 36 is connected at a rear end thereof to rib 38. Seal 32 is fitted onto a rear edge of the upper surface of cover 36 so as to prevent air or water from entering the edge of bonnet 30.

Air cleaner 34 is disposed in a vacant space in the engine room. In this embodiment, stay 35 is fixed to rib 38 and is extended forward from rib 38 and air cleaner 34 is disposed in the upper middle space in bonnet 30 and is supported by stay 35 without no additional support member standing from the lower portion of frames 9, thereby enhancing an available space in bonnet 30. Therefore, stay 35 serving as the member for supporting air cleaner 34 does not obstruct the airflow in bonnet 30. A seal 33 is provided on the portion of rib 38 surrounding stay 35 so as to prevent air from leaking out through the portion.

Description of the working vehicle serving as an application of the invention is concluded.

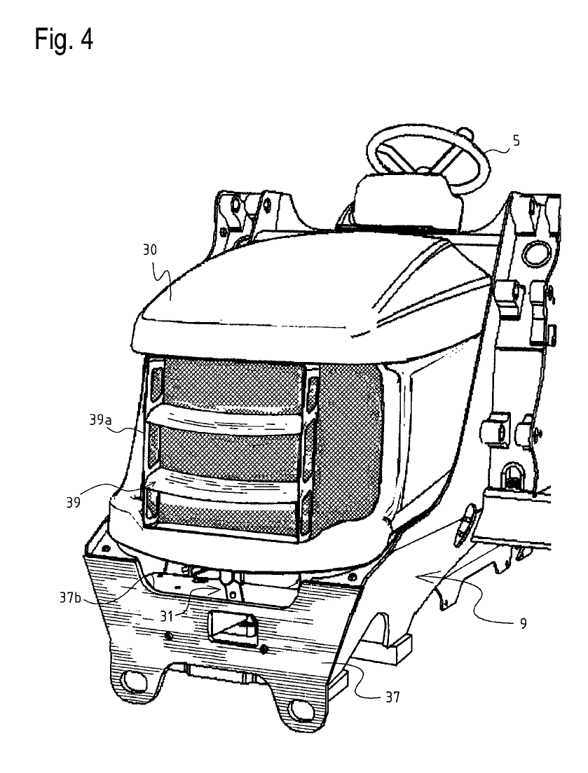

A state of the working vehicle provided with the front guard serving as the subject of the invention will now be described with reference to FIGS. 4 to 6.

As shown in FIG. 4, a front guard 10 is disposed just in front of bonnet grill 39 at the front portion of bonnet 30.

Front guard 10 includes a pair of right and left vertical frames 10a and a plurality of vertically aligned laterally horizontal frames 10b, and is supported by a bracket 11 disposed on a front surface of front plate 37.

As shown in FIG. 4, each of vertical frames 10a is a long flat plate which is expanded forward or rearward at a lower portion thereof for reinforcement, and the expansion shape is determined so as to have an appropriate modulus of section considering a bending stress applied thereon.

Each of horizontal frames 10b is a pipe bent at right and left ends thereof rearwardly slantwise on a horizontal surface so as to fit the shape of the front end portion of bonnet 30 and has a lateral width that is slightly longer than the lateral width of bonnet 30.

The pair of right and left vertical frames 10a are disposed in parallel. The pair of upper and lower frames 10b that are laterally spanned between right and left vertical frames 10a and are joined to upper half portions of vertical frames 10a by welding. Vertical frames 10 a are higher at tops thereof than the top of bonnet grill 39, and are disposed forward from the front ends of horizontal frames 10b. Therefore, the front portion of bonnet 30 is protected.

In this embodiment, the front guard comprises the pair of vertical frames 10a and the pair of horizontal frames 10b. However, the front guard as an application of the present invention is not limited in shape and structure.

As shown in FIG. 4, bracket 11 includes a pair of right and left independent brackets 11R and 11L. Bracket 11L is a member, such as a steel plate, which is substantially L-like bent when viewed in plan so as to have two side surfaces. The surface of bracket 11L to be attached (to contact front plate 37) is provided with a pair of upper and lower bores for passing respective bolts 19 for fastening bracket 11L to the main body. The outer surface of bracket 11L is formed with a hole for passing a bolt 12 for fastening vertical frame 10a to bracket 11L, and with a penetrating hole 11a for passing a retaining pin 16. Bracket 11R is formed laterally symmetric with bracket 11L.

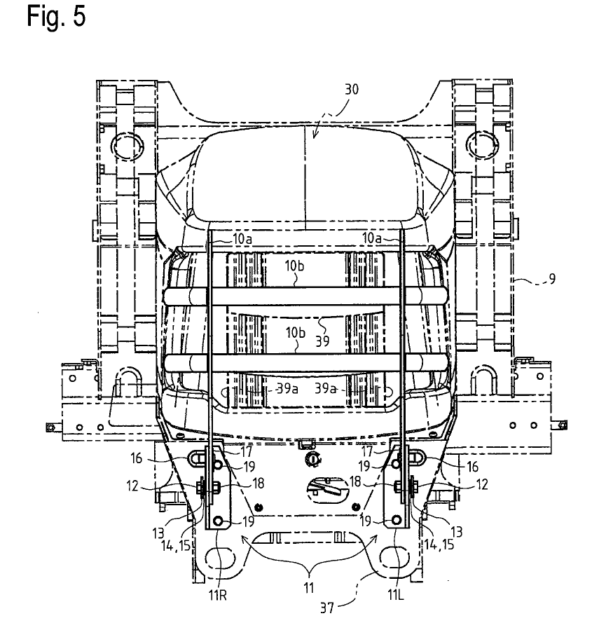

As shown in FIG. 4 or 5, in this embodiment, right and left independent brackets 11R and 11L serving as bracket 11 are fixed to front plate 37 by respective bolts 19.

However, the bracket as an application of the invention is not restricted in shaped and structure.

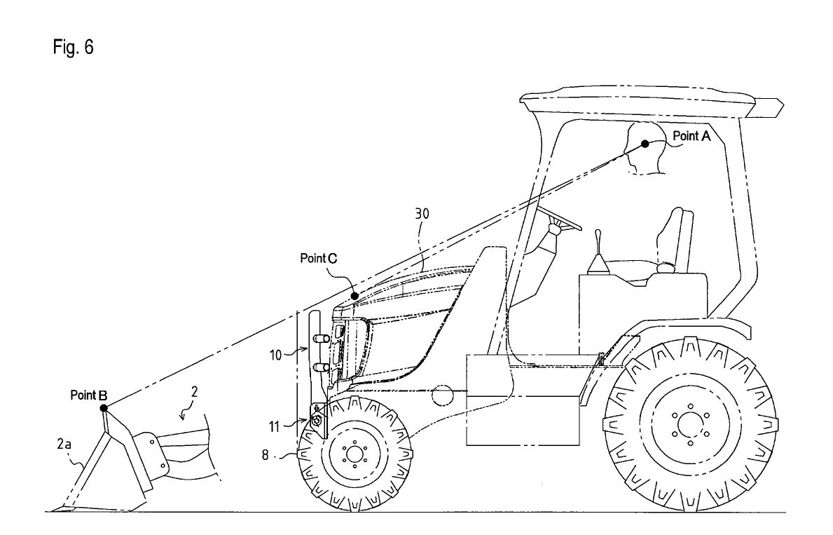

As shown in FIG. 6, front guard 10 is configured so as to be disposed rearward from front ends of front wheels 8. In other words, front guard 10 is disposed at a front end thereof behind the front ends of front wheels 8. In this way, when front guard 10 is vertically mounted, front guard 10 is disposed rearward from front wheels 8 so as not to reduce the workability while keeping the turning radius of the vehicle body.

Further, the top of front guard 10 is substantially as high as the front top of bonnet 30 so as to be seen by the operator sitting on operation seat 6, however, so as not to obstruct the operator's eyeshot.

More specifically, as shown in FIG. 6, a point A is assumed on the center of the operator's head (or eyes), and a point B indicates the minimum height of the top or front end of bucket 2a (or a front-mounted working device) when lowered bucket 2a is put on the ground. A line connecting points A and B does not intersect front guard 10. The front top of bonnet 30 is indicated as a point C. A line connecting points A and C intersects front guard 10. In this way, the front guard is determined in position, size and so on so that front guard 10 is visible at the top thereof. In other words, when the operator's eyeshot (the line connecting points A and B) is focused on the top or front end of bucket 2a, the top of front guard 10 is disposed lower than the eyeshot, so that only the top of front guard 10 is seen above bonnet 30. In this way, when bucket 2a is lowered, the eyeshot to the top of bucket 2a for working is not obstructed by the top of front guard 10, however, the top of front guard 10 constantly exists in the ken for working so as to be focused for turning the working vehicle.

In this way, the top of front guard 10 slightly projects upward from the eyeshot of the operator sitting on operation seat 4, the eyeshot being directed to the front upper portion of bonnet 30, so that the top of front guard 10 can be seen by the operator and does not obstruct the operator's ken for working. Therefore, front guard 10 protects the vehicle body without reducing the workability.

Description of the state of the working vehicle equipped with the front guard as the subject of the invention is concluded.

### INDUSTRIAL APPLICABILITY

The front guard of a working vehicle according to the invention is adaptable to other type vehicles such as automobiles as well as working vehicles.

1. A front guard of a working vehicle, the front guard being mounted to a bracket fixed on a front portion of a vehicle body frame of the working vehicle and disposed in front of the bonnet, wherein a top of the front guard slightly projects upward from an eyeshot of an operator sitting on an operation seat, the eyeshot being directed to a front upper portion of the bonnet, so that the top of the front guard can be seen by the operator and does not obstruct the operator's ken for working.
